(19) United States
(12) Patent Application Publication
(10) Pub. No.: US 2013/0081530 A1
(43) Pub. Date: Apr. 4, 2013

(54) GUITAR PICK STORAGE ELEMENT

(71) Applicants: Joseph Risolia, Miami Beach, FL (US); Jacob Levy, Miami Beach, FL (US)

(72) Inventors: Joseph Risolia, Miami Beach, FL (US); Jacob Levy, Miami Beach, FL (US)

(21) Appl. No.: 13/629,333

(22) Filed: Sep. 27, 2012

Related U.S. Application Data
(60) Provisional application No. 61/626,577, filed on Sep. 29, 2011.

(51) Int. Cl. G10D 3/16

(52) U.S. Cl. CPC G10D 3/163
USPC 84/322

(57) ABSTRACT

There is an instrument pick capable of strumming and/or picking strings of a guitar, the instrument pick configured to store digital data within a storage element, according to one embodiment of the invention. The instrument pick includes a body having a storage element disclosed therewith.

### CROSS-REFERENCE TO RELATED APPLICATION

This application claims the benefit of priority under 35 U.S.C. §119(e) to U.S. Provisional Patent Application No. 61/626,577, filed Sep. 29, 2012, the entirety of which is incorporated by reference. Applicant hereby incorporates by reference herein the subject matter and teachings of U.S. patent application Ser. No. 13/488,281, filed Jun. 04, 2012. Applicant hereby incorporates by reference herein the subject matter and teachings of U.S. Pat. No. 7,956,264.

### FIELD OF THE INVENTION

The present invention relates generally to musical instruments, and more particularly relates to a guitar pick having a storage element disposed therewith.

### BACKGROUND OF THE INVENTION

A guitar pick is a type of plectrum designed for use on a guitar. Over time people have made picks of various materials, including plastic, rubber, felt, tortoiseshell, wood, metal, glass, and stone. They most often take the shape of an acute isosceles triangle with the two equal corners very rounded and the third corner rounded to a lesser extent. This shape is, however, merely one of many used by manufacturers.

Pick shapes started with guitarists filing down bone, shell, wood, cuttlebone, metal, amber, stone or ivory to get the desired shape. Most users of picks are familiar with the most popular shape, the 351, which is merely the rounding off of the top of a heart, which was a popular pick shape early on. The rounded triangle is the 346 and the small jazz pick, the 358.

Guitar picks vary in thickness to accommodate different playing styles and kinds of strings. Thinner plectra are more flexible and tend to offer a wider range of sounds, from soft to loud, and produce a “click” that emphasizes the attack of the picking However, some argue that heavier picks produce a brighter tone. Picks are usually gripped with two fingers—thumb and index—and are played with pointed end facing the strings. However, it is a matter of personal preference and many notable musicians use different grips.

The motion of the pick against the string is also a personal choice. George Benson and Dave Mustaine, for example, hold the pick very stiffly between the thumb and index finger, locking the thumb joint and striking with the surface of the pick nearly parallel to the string, for a very positive, articulate, consistent tone. Other guitarists have developed a technique known as circle picking, where the thumb joint is bent on the downstroke, and straightened on the up stroke, causing the tip of the pick to move in a circular pattern. Circle picking can allow greater speed and fluidity. The angle of the pick against the string is also very personal and has a broad range of effects on tone and articulation. Many rock guitarists will use a flourish (called a pick slide or pick scrape) that involves scraping the pick along the length of a round wound string (a round wound string is a string with a coil of round wire wrapped around the outside, used for the heaviest three or four strings on a guitar).

Some improvements have been made in the field. Examples of references related to the present invention follow and are presented for their supported teachings, which are incorporated by reference herein: U.S. Pat. No. 5,488,892, issued to Jepsen; U.S. Pat. No. 4,785,708, issued to Vaughan; U.S. Pat. No. 4,982,641, issued to Duhart; U.S. Pat. No. 4,303,062, issued to Vars; U.S. Pat. No. 6,245,006, issued to Olson; and U.S. Pat. No. 4,137,814 issued to Rowley.

The inventions heretofore known suffer from a number of disadvantages which include being limited in application, being limited in adaptability, being expensive, being nondurable, being flimsy, being heavy, being inconvenient and being difficult to use.

Guitar picks are often given as gifts, in particular, as promotional items from those in the music or related industries. To date, the amount of advertising surface of the pick is limited to the upper and lower surfaces. Due to their small size, this space limitation is very restrictive and usually only accommodates the logo of the gifting entity or, at most, a few words. There is a need for a guitar pick gift that would allow the recipient to learn about the gift-giving entity, for example, be able to see a video of who they are and what they do, view pictures, read relevant text, hear sound clips, and much more. Further, to date, there is a need for a collectable guitar pick for having a music album, video and other digital data stored therewith.

Yet further, guitarists have found that it is cumbersome to carry, in addition to a guitar pick, a separate device having memory. Additionally, a stack of sheet music can be thick, heavy and inconvenient for transportation purposes. It is particularly cumbersome when the guitarist must carry, in addition to the guitar pick, a guitar and a speaker system. Resultantly, there is a need for a guitar pick that includes a memory configured for storing songs, videos, music note sheets.

Therefore, a need exists to overcome the problems with the prior art as discussed above.

### SUMMARY OF THE INVENTION

The invention provides a guitar pick storage element that overcomes the hereinafore-mentioned disadvantages of the heretofore-known devices and methods of this general type and that provides a convenient and portable apparatus for transporting digital information, such as music. It is particularly useful to overcome the shortcoming of other storage devices. Namely, this invention provides for the combination of a guitar pick and a storage element. This is particularly useful and convenient for storing and transferring music and videos for a music artist. In this way, the artist will always have his/her music available when out playing music. Additionally, the artist can record new music and subsequently store that music to the guitar pick.

With the foregoing and other objects in view, there is provided, in accordance with an embodiment of the present invention, an instrument pick configured to facilitate play. The instrument pick comprises an instrument pick; and a storage element coupled to said instrument pick and configured to store digital data.

In accordance with a further feature of the present invention, the body comprises a hinge configured for facilitating rotation of said storage element about said base. A magnet is coupled to said body. The magnet is configured for coupling to a metal surface of a stringed instrument.

In accordance with a further feature of the present invention, a method includes crafting a body for facilitating music notes. The body comprises a base for gripping and a storage element for storing digital data.

Although the invention is illustrated and described herein as embodied in a guitar pick storage element, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of an instrument pick capable of strumming and/or picking strings of an instrument, the instrument pick configured to store data within a storage element in accordance with the principles of the present invention.

FIG. 2 is a perspective partial view of the instrument pick with the storage element rotatably displaced with relation to the plectrum of the instrument pick in accordance with the principles of the present invention;

FIG. 3 is a perspective view of the storage element removably in electrical communication with a computing device in accordance with the principles of the present invention;

FIG. 4 is a perspective view of an instrument pick capable of strumming and/or picking strings of an instrument, the instrument pick configured to store data within a storage element in accordance with the principles of the present invention;

FIG. 5 is a perspective partial view of the storage element that can be slidably displaced with relation to the plectrum of the instrument pick in accordance with the principles of the present invention;

FIG. 6 is a perspective view of the storage element removably in electrical communication with a computing device in accordance with the principles of the present invention;

FIG. 7 is an instrument pick having a storage element, the instrument pick is magnetically coupled to a portion of the instrument in accordance with the principles of the present invention;

FIG. 8 is a rear view of a magnetic instrument pick in accordance with the principles of the present invention;

FIG. 9 is an exploded frontal view of an instrument pick in accordance with the principles of the present invention; and

FIG. 10 is a frontal view of the instrument pick having the cover configured to conceal the connector in accordance with the principles of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient instrument pick that is capable of strumming and/or picking strings of an instrument. The instrument pick, in accordance with one embodiment, is also configured to store data within a data storage element.

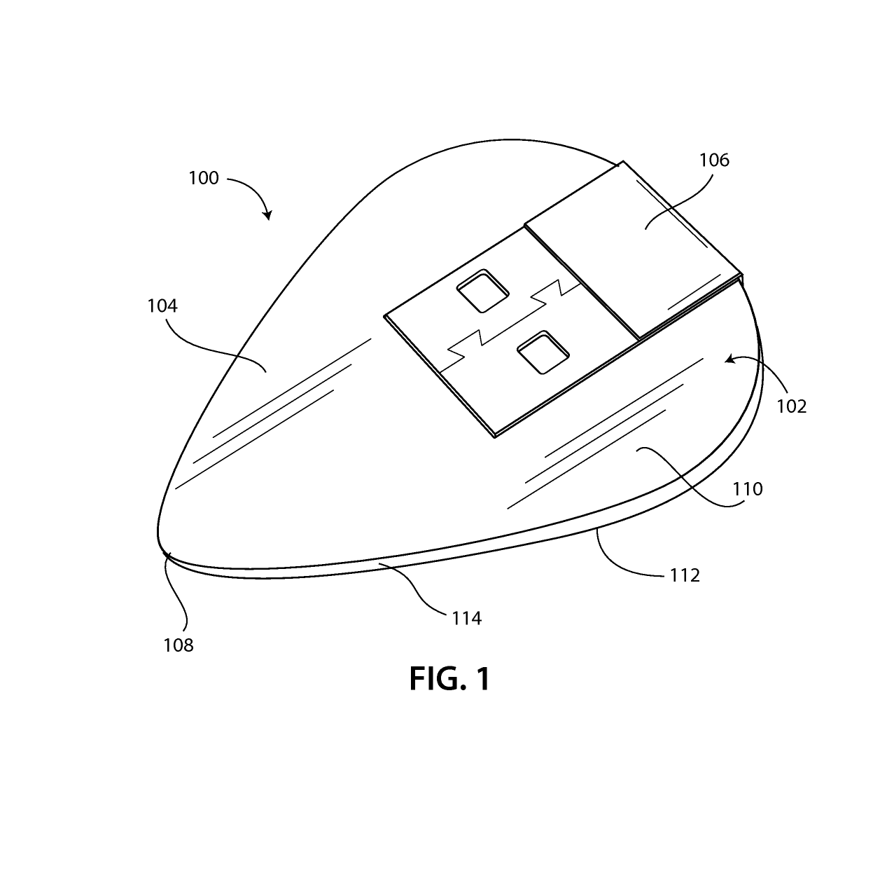

Referring now to FIG. 1, one embodiment of the present invention is shown in a perspective view. FIG. 1 shows several advantageous features of the present invention, but, as will be described below, the invention can be provided in several shapes, sizes, combinations of features and components, and varying numbers and functions of the components. The first example of an instrument pick 100, as shown in FIG. 1, includes a body 102. The body includes at least an upper surface 110 and a lower surface 112. The upper surface 110 and the lower surface 112 can each be referred to interchangeably herein as “the surface.”

As further depicted in FIG. 1, the body 102 includes a base 104 and a storage element 106 in a closed position. The storage element 106 is configured for storing digital data. In an embodiment, the storage element 106 may be, inter alia, a USB memory, flash memory or any other memory capable of storing digital data.

In an embodiment, the instrument pick 100 is configured for strumming and/or picking strings of an instrument. The instrument may include, inter alia, a guitar, banjo, harp, lute, mandolin, oud, sitar and any other stringed instrument. The base 104 includes a peripheral flange 108 configured for contacting the strings of an instrument. The base may be formed from any material that can be configured for contacting the strings of an instrument.

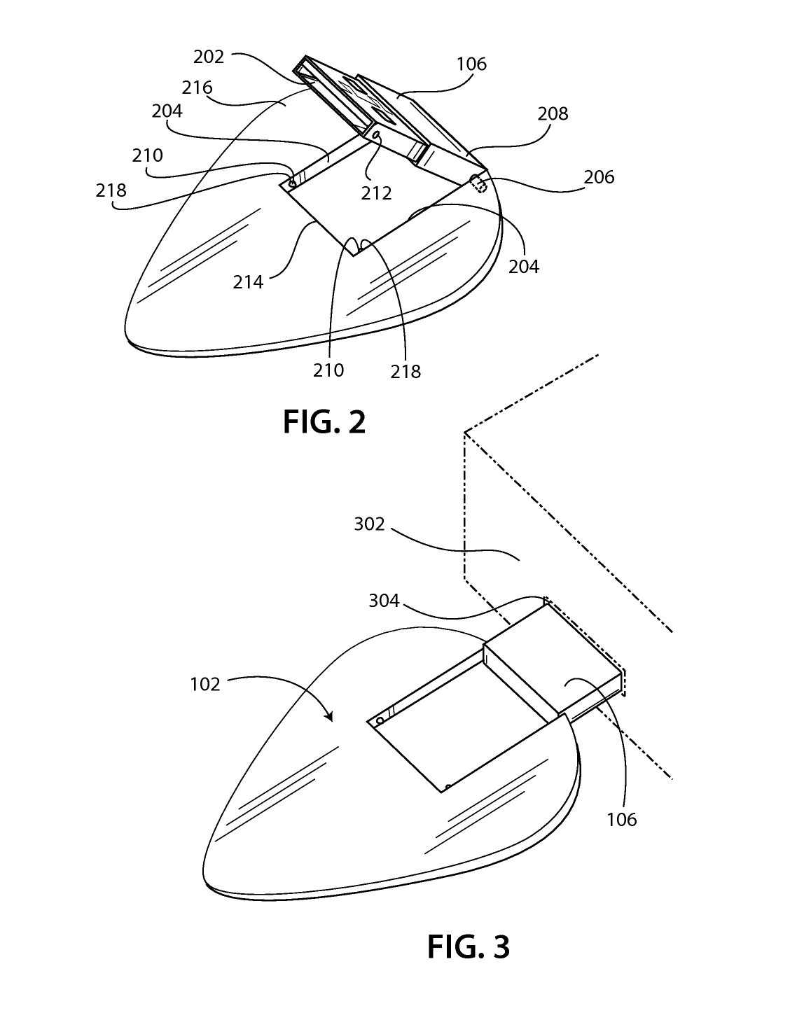

Referring now to FIG. 2, a partial view of the instrument pick 100 depicting the storage element 106 is shown in a partially opened position. The storage element 106 can be rotatably displaced with relation to the base 104 of the instrument pick in accordance with the principles of the present invention. The storage element 106 is coupled in hinged relation to the base 104 at a proximal end 208 of the storage element 106. The hinge 206 permits at least about 90 degrees of rotation. FIG. 3 depicts 180 degree rotation of the storage element 106 about the base 104, but rotation as much as 360 degrees is possible.

The base 104 includes interior side wall 204 having a depth defined by a distance between the upper and lower surfaces 110 and 112. In an embodiment, the interior sidewall 204 may be of a depth that is approximately equivalent to a depth of the storage element 106, causing an at least substantially flush arrangement of the surfaces 110 and 112 in relation to the storage element 106 when the storage element 106 is in a closed position.

Interior side wall 204 and storage element 106 may include a locking mechanism to prevent storage element 106 rotating to an at least partially open position. For exemplary purposes, at least one protrusion 210 and at least one aperture 212 are configured to frictionally mate for providing resistance against opening.

FIG. 3 is a perspective view of the storage element 106 removably in electrical communication with a computing device 302 in accordance with the principles of the present invention. The storage element 106 is removably coupled with a port 304 of the computing device, permitting uploading and downloading of information from the storage element 106 to the computing device 302. Further, FIG. 3 depicts the storage element 106 configured to communicate with a computing device 302 through a USB port, however, it is contemplated that the storage element 106 may be configured to communicate through any port capable of facilitating electrical communication between the storage element 106 and the computing device 302.

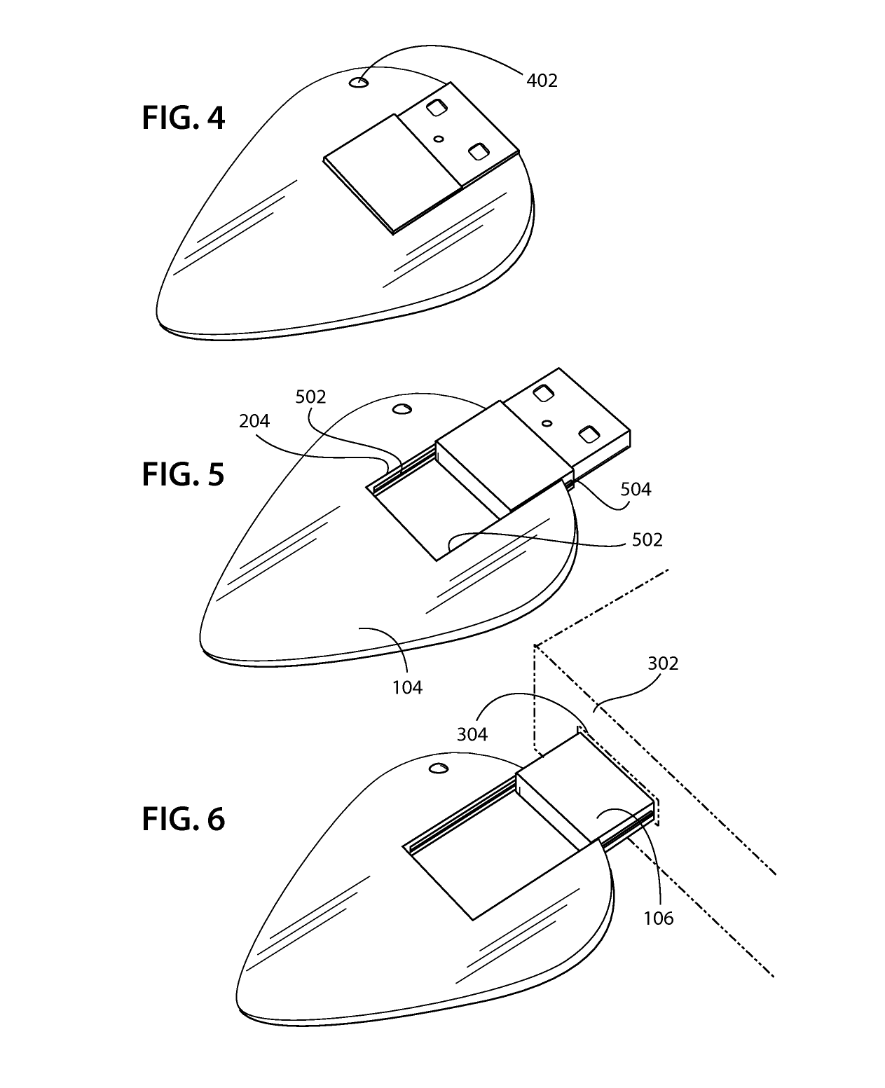

FIG. 4 is a perspective view of an instrument pick capable of strumming and/or picking strings of an instrument, the instrument pick configured to store data within a storage element and also to hang from a key chain in accordance with the principles of the present invention. The instrument pick includes an aperture 402 adapted for connection to a key chain, leash, or other similar tethers.

FIG. 5 is a partial view of the storage element that is slidably displaced to an open position with relation to the plectrum of the instrument pick in accordance with the principles of the present invention. The interior side wall includes one of at least one groove and at least one tongue or at least one of both the groove and the tongue, defining an interior side wall connection assembly 502. Additionally, the storage element includes one of at least one groove and at least one tongue or at least one of both the groove and the tongue, defining a storage element connection assembly 504. The interior side wall connection assembly 502 and the storage element connection assembly 504 are in reciprocating relation allowing the storage element 106 to be slidably displaced about the base 104.

FIG. 6 is a perspective view of the storage element removably in electrical communication with a computing device in accordance with the principles of the present invention. The storage element 106, in a slidingly open position, is connected via a port 304 to the computing device 302.

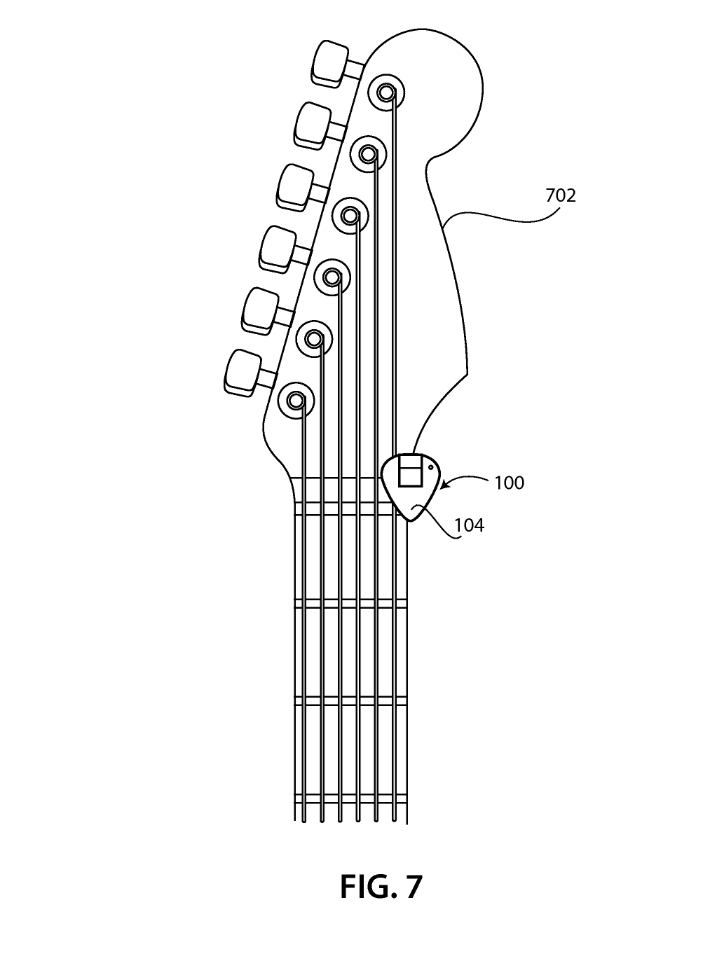

FIG. 7 depicts a magnetic guitar pick and, more specifically, a perspective view of a magnetic guitar pick coupled to a guitar string, according to one embodiment of the invention. There is an instrument pick 100 configured to selectably couple to a metal surface of an instrument 702. In an embodiment, the instrumental pick 100 includes a lower surface 112 having a magnet disposed on the lower surface 112 of the body 102.

For example, although the Figures illustrate an instrument pick selectably coupled to a guitar string of a guitar, one skilled in the art would appreciate that the instrument pick may couple to any metal surface of an instrument not limited to guitar strings and not limited to guitar and still perform its intended function. In addition, the instrument pick may include a plurality of magnets disposed on either surface of the base member, within the base member, and in any configuration, magnetic orientation, design about the base member, and still perform its intended function.

In operation of one embodiment of the invention, the user grips the magnetic guitar pick and strums guitar strings of a guitar. The user disposes the body 102 about a guitar string, bridge, or neck of a guitar and the magnet selectably couples to the metal of the guitar strings, bridge, or neck of the guitar, thereby securing the magnetic guitar pick to the guitar.

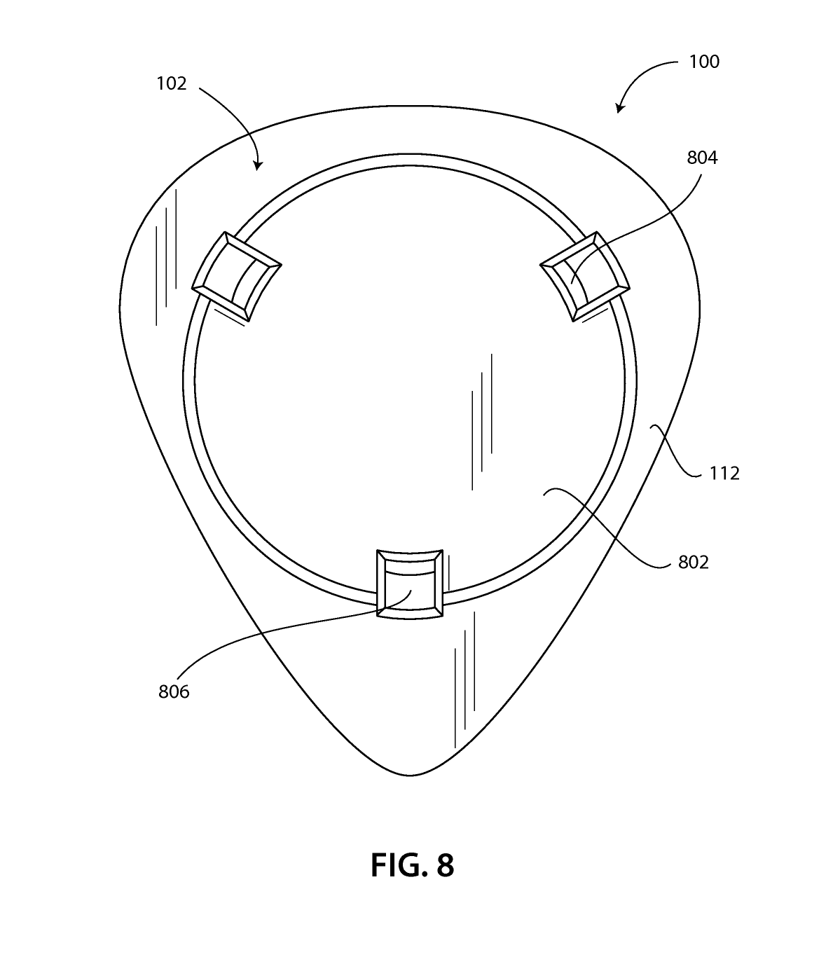

FIG. 8 is a perspective view of a magnetic guitar pick, according to one embodiment of the invention. There is an instrument pick 100 configured to selectably couple to a metal surface of an instrument. The instrumental pick 100 includes a body 102 having an interior cavity 802 and at least one magnet 804 disposed within the interior cavity 802 of the body 102. The body 102 of the instrumental pick 100 also includes a plurality of apertures 806 configured to accept and hold dispose a portion of the magnet 804. As illustrated in FIG. 8, the instrument pick 100 includes a magnet 804 disposed within the body 102.

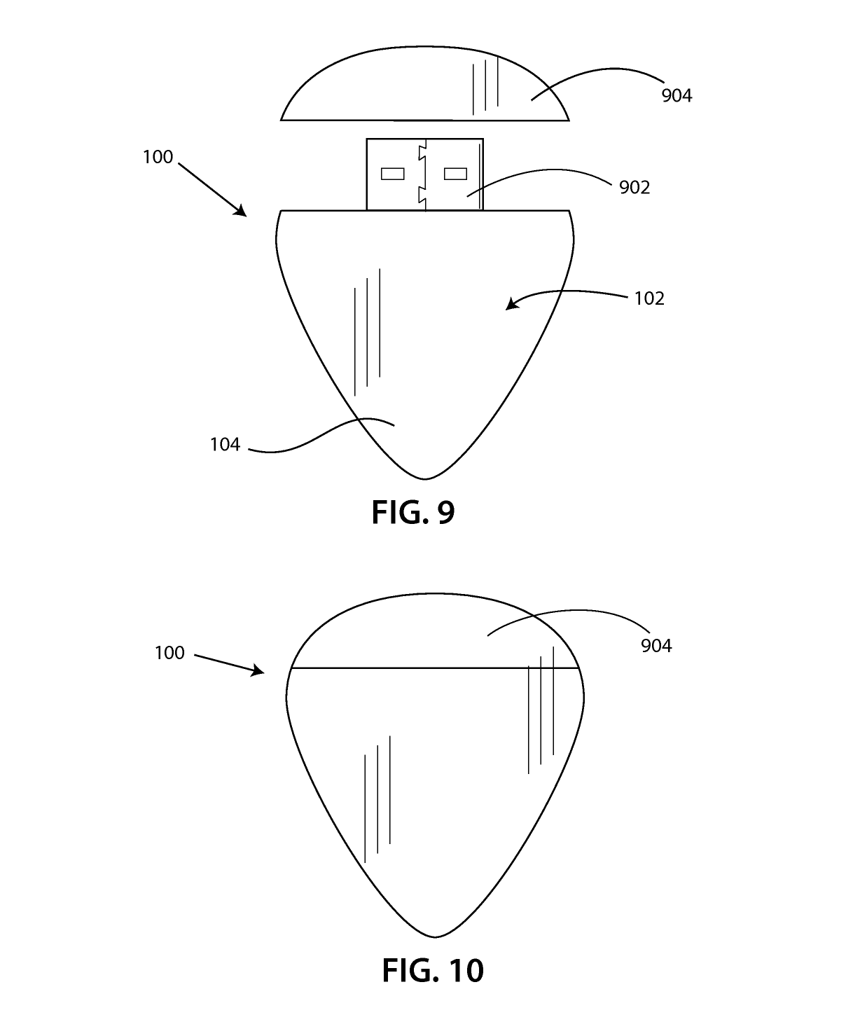

FIG. 9 depicts an instrument pick in accordance with the principles of the present invention. The instrument pick 100 includes a body having a base and a storage element. The base is configured to strum and/or pick strings of an instrument, the instrument pick configured to store data within a storage element positioned within the body 102. The instrument pick includes a connector 902 that mates with a computing device 302 (shown in FIG. 3) for uploading and downloading digital data from the storage element 106. The computing device may be one of, inter alia, a desktop computer, laptop, smartphone, tablet device and an mp3 player. As depicted in FIGS. 9 and 10, the instrument pick includes a cover 904 configured to conceal the connector 902. In operation of one embodiment, the cover mates with the body 102 to provide an instrument pick. Further, the cover is removed to allow access to the connector 902 for uploading and downloading information to and from the storage element. This allows a user to ability to create music with the instrument pick and subsequently save that work to the pick. This is beneficial, among other reasons, to reduce the number items that the user must carry with him/her while out playing music.

The instrument pick 100 may be formed as a gift, and in particular, as promotional item from those in the music or related industries. Alternatively, the instrument pick 100 may be a gift from a family member or a friend. The instrument pick 100 provides unrestricted space, limited only by the memory of the instrument pick 100, to store music, music albums, videos, sheet music, back up signing voices, additional instrument beats and the like.

The instrument pick 100 provides to the recipient the ability to learn about the gift-giving entity, such as a band or concert promoter, and for example, be able to see a video of who they are and what they do, view pictures, read relevant text, hear sound clips, and much more.

Yet further, guitarists have found that it is cumbersome to carry, in addition to a guitar pick, a separate device having memory. Additionally, a stack of sheet music can be thick, heavy and inconvenient for transportation purposes. It is particularly cumbersome when the guitarist must carry, in addition to the guitar pick, a guitar, a speaker system and sheet music, among other music equipment. Resultantly, the instant instrument pick 100 satisfies a need to reduce the items that the guitarist must carry with him/her.

In an operation, a guitar itself may include a port that allows digital communication between the guitar pick and the storage element 106. The guitar may output music to a speaker, wherein the output music is generated based on the digital data within storage element 106. In operation, the storage element 106 may include backup music that is played from the guitar itself This allows the guitarist to play his/her music with other music that the guitarist received or otherwise recorded at an earlier point in time.

In an operation, the instrument pick 100 could be used to upload and/or otherwise play music directly from a speaker. In this manner, the storage element 106 mates to a port on the speaker to allow communication of the digital data to the speaker.

In yet a further embodiment, the instrument pick 100 could be used to provide sheet music to a display screen. It would be particularly useful for the guitarist to carry an instrument pick 100 that contains all of his/her sheet music because sheet music is heavy and cumbersome.

In yet a further embodiment, the instrument pick 100 is convenient for individuals to swap music by trading guitar picks. In an embodiment, the instrument pick 100 itself is of great value. For example, the instrument pick 100 may include indicia of a particular band.

Additionally, an instrument pick having a storage element is particularly useful for guitarists because guitarists typically have a lucky guitar pick. Guitarists are thus less likely to lose or misplace their lucky guitar pick with a storage element than other well-known types of storage element devices. Furthermore, guitarists are less likely to separate their guitar picks from their guitars, further reducing the likelihood of misplacing the guitar pick. In this way, the guitarist will have their guitar pick having digital data at all critical times.

What is claimed is:

1. An assembly configured to facilitate play, the assembly comprising:
an instrument pick; and
a storage element coupled to said instrument pick and configured to store digital data.

2. The assembly of claim 1 wherein said storage element is movable in relation to said instrument pick.

3. The assembly of claim 2 wherein said storage element is configured to move in hinging relation about said instrument pick.

4. The assembly of claim 2 wherein said storage element is configured to move in sliding relation about said instrument pick.

5. The assembly of claim 1 wherein said storage element is configured to mate with a USB port.

6. The assembly of claim 1 wherein said storage element is configured to mate with one of a smartphone and a tablet computing device.

7. The assembly of claim 1 wherein said instrument pick is substantially teardrop shaped.

8. The assembly of claim 1 wherein said instrument pick is configured to receive a signature.

9. The assembly of claim 1 wherein said instrument pick is configured to couple with a key chain.

10. An assembly configured to facilitate music notes, the assembly comprising:
a guitar pick for contacting strings of a stringed instrument;
a storage element coupled to the guitar pick, said storage element configured for storing digital data;
a hinge configured for facilitating rotation of said storage element about said guitar pick;
a magnet coupled to said guitar pick, said magnet configured for coupling to a metal surface of a stringed instrument.

11. A method comprising:
providing an instrument pick for facilitating music notes, said instrument pick comprising:
a base for gripping; and
a storage element coupled with said base, said storage element configured for storing digital data.

12. The method of claim 11, further including providing said storage element in movable relation to said base.

13. The method of claim 12, further including providing said storage element in hinging relation about said base.

14. The method of claim 12, further including providing said storage element to move in sliding relation about said base.

15. The method of claim 11, further including providing said instrument pick to mate with a USB port.

16. The method of claim 11, further including providing said instrument pick into substantially a teardrop shape.

17. The method of claim 11, further including providing said instrument pick from materials capable of receiving a signature.

18. The method of claim 11, further including providing said instrument pick to couple with a key chain.
